(19) United States
(12) Patent Application Publication
(10) Pub. No.: US 2007/0164512 A1
(43) Pub. Date: Jul. 19, 2007

(54) Domino counter

(76) Inventor: Robert F. Beavers, Muncie, IN (US)

Correspondence Address: MILTON ROBERT KESTENBAUM;(a.k.a. ROBERT KESTENBAUM), 11011 BERMUDA NE, ALBUQUERQUE, NM, 87111, US

(21) Appl. No.: 11/653,633

(22) Filed: Jan. 16, 2007

Related U.S. Application Data
(60) Provisional application No. 60/759,871, filed on Jan. 17, 2006.

(51) Int. Cl. G06F 19/00; A63F 9/00

(52) U.S. Cl. 273/148 R; 463/11

(57) ABSTRACT

A domino counter provides a method that uses a device for counting and adding dots on dominos and keeps score for one to eight players. The device provides a unit that uses a scanning or imaging device to read and count dots on a domino. When a user places the counting unit over the domino, a sensor or switch detects the domino and starts operation. The displayed count updates and the unit beeps when done. The display shows the accumulated count as successive dominos are read for each player. When a reset button is pressed, the device clears the accumulated count before the next user begins.

### CROSS-REFERENCE TO RELATED APPLICATIONS

This is a Non-Provisional application claiming priority of Provisional Application 60/759,871, filed on Jan. 17, 2006.

### STATEMENT REGARDING FEDERALLY SPONSORED RESEARCH OR DEVELOPMENT

Not applicable.

### BACKGROUND OF THE INVENTION

1. Field of the Art

This invention relates to a domino counter, and more particularly, to a scanning or imaging device to read and count the dots on a domino.

2. Description of Related Art

Dot-matrix printers are known that form dots in a dot-matrix pattern representing a character and comprise a means for setting up a predetermined number of vertical rows and dots in a print line and means for storing the number of dots that are formed.

### BRIEF SUMMARY OF THE INVENTION

It is an object of the present invention to provide a method for counting and adding dots on dominos and keeping score for one to eight players. Another object of the invention is to provide a unit that uses a scanning or imaging device to read and count dots on a domino.

### BRIEF DESCRIPTION OF THE SEVERAL VIEWS OF THE DRAWINGS

FIG. 1 shows a top view of the counter with an indicator light, a count indication on a LED Display, and a reset button.

FIG. 2 shows a side view of the counter, which may be shaped like a plastic cup.

FIG. 3 shows a domino to be counted.

FIG. 4 shows the LCD display.

FIG. 5 shows a circuit diagram of the counter, including a lens, a camera chip, a microcomputer with an external memory, an LCD display, a battery-operated power circuit, and a speaker or buzzer.

FIG. 6 shows an alternate embodiment of a circuit diagram of the counter, including a lens, a camera chip, a microcomputer with an internal memory, an LCD display, and a battery-operated power circuit.

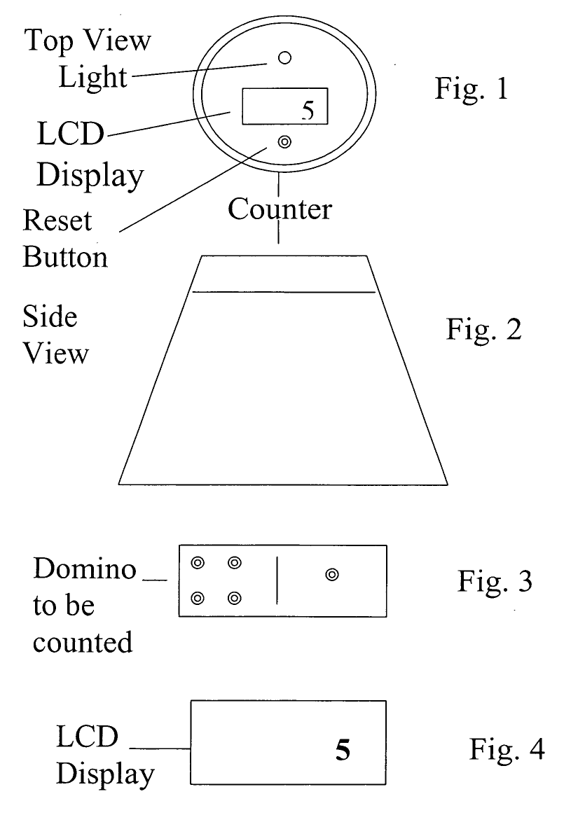

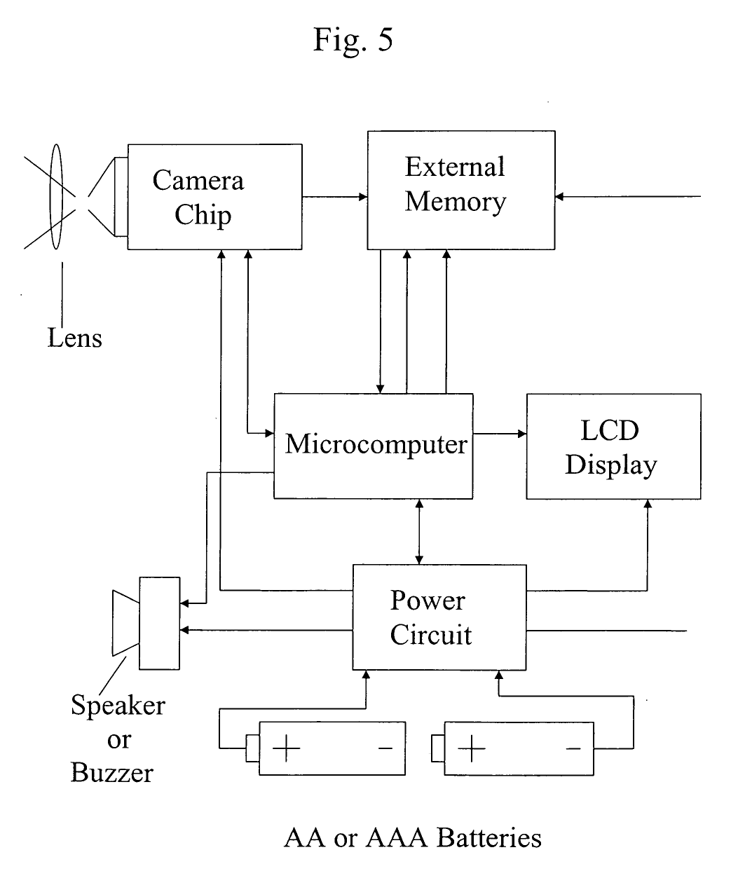

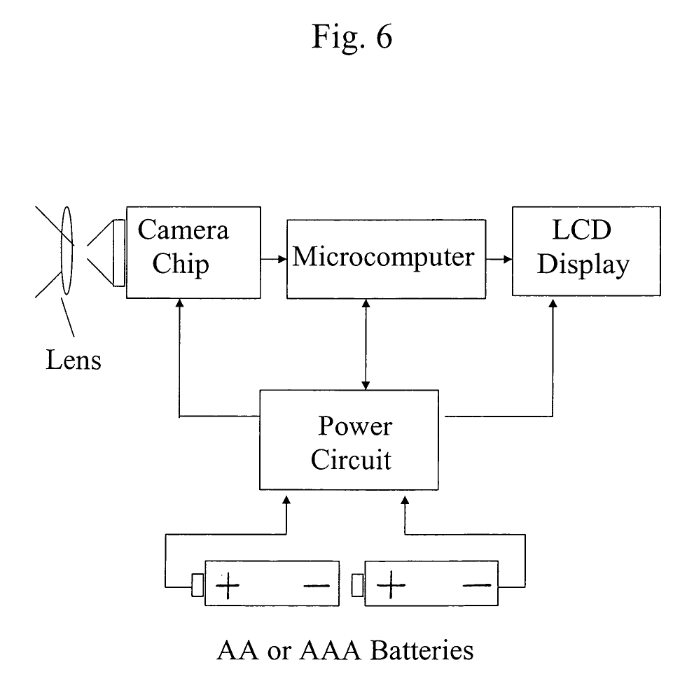

### DETAILED DESCRIPTION OF THE INVENTION

According to the present invention, the method to count dots on dominos and to keep score uses a small unit that includes a scanning or imaging device to read and count the dots. The device reads one domino at a time. The domino is placed flat (dots up) on a table in any orientation. Optionally, a shroud may be used to control light levels and reflections. The device uses a simple four digit LCD display, possibly with some custom icons. In one embodiment, the device will total individual hands only. In an alternative embodiment, the device also does score keeping and displays the scores for up to eight players.

In an electronic configuration a micro computer accepts the image data, processes the data to find and count the dots and shows the results on an LCD display. The imaging device can be a camera chip that is used in cell phones, etc. An external memory can be used to store data, depending upon the complexity of the analysis. Circuitry regulates the battery output and shuts down the power whenever the device is not in use. Minimum controls are provided and include just one push button. A “done” indicator uses a beep or a light to signal when the reading is complete and valid. A different beep indicates a bad reading or a problem, such as when there is no domino or the domino is upside down.

The user interface calls for the device to operate when placed over a domino. The user can count score by going from domino to domino until all dominos have been counted. The dominos will need to be on their back (dots up), but orientation does not matter. A speaker or buzzer indicates the count is complete.

The method of the invention provides that (1) the user places the counting unit over the domino; (2) a sensor or switch detects the domino and starts operation; (3) the displayed count updates; and (4) the unit beeps or buzzes to indicate the method is done. The display will show the accumulated count as successive dominos are read. When a reset button is pressed, the device clears the accumulated count before the next user begins.

This method and device may also be used in other embodiments, for example, it may be used as an aide for teaching mathematics.

What is claimed is:

1. A method to count dots on dominos and keep score comprising:
placing a counting unit over a domino;
detecting the domino and starting operation;
displaying the count and updating the count;
signaling to indicate the counting is completed; and
clearing the accumulated count before the next user begins.

2. An imaging device for counting dominos comprising:
a lens;
a camera chip activated by light passing through the lens;
a microcomputer that receives data from the camera chip;
a display that displays an image from the microcomputer; and
a power circuit that powers the imaging device.

3. The device of claim 2, further comprising an external memory device connected to the microcomputer.

4. The device of claim 2, further comprising a device that combines the lens and imaging device into a single assembly.

5. The device of claim 3, further comprising a device that combines the lens and imaging device into a single assembly.

6. A device according to claim 2, further comprising a sensor that provides the detection and starts the counting operation.

7. A device according to claim 6, further comprising a sensor that provides the detection and starts the counting operation.

8. A device according to claim 6, further comprising a camera chip in the imaging device that detects the counting operation.

9. A device according to claim 6, in which the device further comprises a display element such as a built-in display or an LCD integrated to indicate the count is complete.

10. A device according to claim 6, further comprising a speaker or a buzzer indicating the count is complete.
